(19) United States
(12) Patent Application Publication
(10) Pub. No.: US 2026/0171659 A1
(43) Pub. Date: Jun. 18, 2026

(54) ANTENNA ENCLOSURE FOR FLOATING ON SWIMMING POOL, CLEANING ROBOT AND METHOD OF USE THEREOF

(71) Applicant: Ningbo POWERFUL Pool Equipment Co., Ltd, Cixi City (CN)

(72) Inventor: Min Li, Cixi City (CN)

(21) Appl. No.: 18/982,818

(22) Filed: Dec. 16, 2024

(51) Int. Cl. H01Q 1/34; E04H 4/12; E04H 4/16

(52) U.S. Cl. CPC H01Q 1/34; E04H 4/1263; E04H 4/1654

(57) ABSTRACT

A cleaning robot includes a first cleaning device and a second cleaning device. The second cleaning device is provided thereon with the antenna enclosure as defined above. The first cleaning device sinks at the bottom of water to clean the bottom of a swimming pool, while the second cleaning device floats on the surface of water to clean the surface of water. The second cleaning device is provided with a first signal cable. A first end of the first signal cable is connected to the antenna enclosure, and a second end of the first signal cable is connected to the first cleaning device. With this arrangement, the antenna enclosure is detachably attached to the second cleaning device, facilitating access to the first signal cable for use and allows replacement by a user with another antenna enclosure optionally with another first signal cable having a different length.

### FIELD OF THE INVENTION

The present invention relates to the field of swimming pool cleaning and, in particular, to an antenna enclosure for floating on a swimming pool, a cleaning robot and a method of use thereof.

### BACKGROUND OF THE INVENTION

Swimming pool cleaning is important to ensuring that water in swimming pools has safe and clear quality. In addition to sanitization, this may also involve removing hairs, leaves, dirt and algae, if present, from swimming pools.

Cleaning is usually carried out manually, namely, by manually scrubbing away dirt and algae from walls and bottom of swimming pools using a brush or cleaner. In the summer, swimming pools are used more frequently, and timely cleaning is necessary, which may also involve draining part of the used water and supplementing fresh water to dilute any pollutant or remaining sanitizer. However, this is costly and generates water flow, which may adversely affect swimming pool users' experience of use.

### SUMMARY OF THE DISCLOSURE

In order to overcome the above-described problems, the present invention provides:
an antenna enclosure for floating on a swimming pool in a first aspect of the present application, which is able to float on the surface of water and provided therein with a reel rotatable with a rotator, the reel provided therein a signal box;
a swimming pool cleaning robot in a second aspect of the present application, which comprises a first cleaning device and a second cleaning device, the second cleaning device provided thereon with the antenna enclosure as defined above, the first cleaning device sinking at the bottom of water to clean the bottom of a swimming pool, the second cleaning device floating on the surface of water to clean the surface of water, the second cleaning device provided with a first signal cable.

A first end of the first signal cable is connected to the antenna enclosure, and a second end of the first signal cable is connected to the first cleaning device.

The antenna enclosure is provided at the bottom of the second cleaning device.

Additionally, the antenna enclosure may comprise a first reel cover and a second reel cover, which are fixedly coupled to each other and together define a lock slot extending therethrough and provided therein with an unlocking means, wherein
the first reel cover and the second reel cover also together define a cable aperture in the vicinity of the lock slot; the first signal cable is passed through the cable aperture of the antenna enclosure and connected to the signal box in the antenna enclosure; and the signal box is provided therein with a signal antenna and a PCB board.

Additionally, the first reel cover of the antenna enclosure may define a male engagement member and the second cleaning device may define a female engagement member complementary to the male engagement member in shape.

Additionally, the unlocking means may be complementary in shape to the lock slot and define stop ribs on its opposite sides and a central cable recess matching the cable aperture in width.

Additionally, the unlocking means may be made of plastic and define reinforcing ribs.

Additionally, the antenna enclosure may be provided with a grip on the side away from the second cleaning device, wherein the reel in the antenna enclosure defines rotating slots, and the grip defines mating rotating teeth capable of insertion into the rotating slots.

Additionally, the first signal cable may be provided with an aviation connector at the second end and connected to the first cleaning device via the aviation connector, wherein:
the antenna enclosure is elliptical and defines grip locations at ends of its long axis and a circular, central cable storage cavity.

Additionally, the male engagement member may comprise a male plug fixed on the side of the first reel cover proximal to the second cleaning device, the male plug defining symmetrical male protrusions, wherein:
the female engagement member comprises a female socket defining female recesses and female protrusions for mating with the male protrusions;
the male protrusions are generally F-shaped and each comprise a leading insertion portion, a trailing securing portion joined to one end of the leading insertion portion and a stop ridge joined to one side of the leading insertion portion; and
the female protrusions define stop grooves for mating with the stop ridges.

In a third aspect of the present application, there is provided a method of using the swimming pool cleaning robot as defined above, which comprises:
an assembly process comprising the steps of:
S1: in response to a need for use, taking the antenna enclosure out and unwinding a length of the first signal cable out of the antenna enclosure, which is 1-1.2 times a depth of water in a swimming pool to be cleaned;
S2: in case of the antenna enclosure being provided with the unlocking means, pressing the unlocking means to unlock the first signal cable, and after an appropriate length of the first signal cable has been unwound out, pressing the unlocking means in the opposite direction to again lock the first signal cable;
S3: in case of the antenna enclosure being provided with the grip, rotating the grip in a first direction to unwind the first signal cable;
S4: connecting the first signal cable to the first cleaning device, wherein in case of the first signal cable being provided with the aviation connector, the aviation connector is tightened into a corresponding feature of the first cleaning device; and
S5: attaching the antenna enclosure to the second cleaning device, wherein in case of the antenna enclosure defining the male engagement member and of the second cleaning device defining the female engagement member, the attachment is accomplished by tightening the male engagement member into the female engagement member in the first direction; and
a disassembly process comprising the steps of:
S6: after use, separating the first signal cable from the first cleaning device, wherein in case of the aviation connector being provided, the separation is accomplished by loosening the aviation connector;
S7: detaching the antenna enclosure from the second cleaning device, wherein in case of the antenna enclosure defining the male engagement member and of the second cleaning device defining the female engagement member, the detachment is accomplished by loosening the male engagement member from the female engagement member in a second direction;
S8: winding the first signal cable back into the antenna enclosure, wherein in case of the antenna enclosure being provided with the unlocking means, the unlocking means is pressed to unlock the first signal cable, and after the first signal cable has been recovered, is pressed in the opposite direction to again lock the first signal cable; and
S9: in case of the antenna enclosure being provided with the grip, rotating the grip in the second direction to wind the first signal cable.

The present invention offers the following benefits: it provides an antenna enclosure for floating on a swimming pool, a cleaning robot and a method of use thereof. The antenna enclosure is able to float on the surface of water and provided therein with a reel rotatable with a rotator. The reel is provided therein a signal box. The cleaning robot comprises a first cleaning device and a second cleaning device. The second cleaning device is provided thereon with the antenna enclosure as defined above. The first cleaning device sinks at the bottom of water to clean the bottom of a swimming pool, while the second cleaning device floats on the surface of water to clean the surface of water. The second cleaning device is provided with a first signal cable. A first end of the first signal cable is connected to the antenna enclosure, and a second end of the first signal cable is connected to the first cleaning device. With this arrangement, the antenna enclosure is detachably attached to the second cleaning device, facilitating access to the first signal cable for use and allows replacement by a user with another antenna enclosure optionally with another first signal cable having a different length or dimension, as required by a particular application or swimming pool depth, thereby resulting in improved applicability.

### BRIEF DESCRIPTION OF THE DRAWINGS

FIG. 1 shows a schematic structural view of an antenna enclosure according to the present invention.

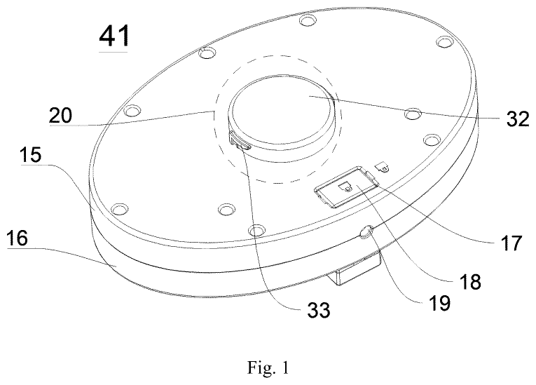

FIG. 2 shows a schematic structural view of a cleaning robot according to the present invention.

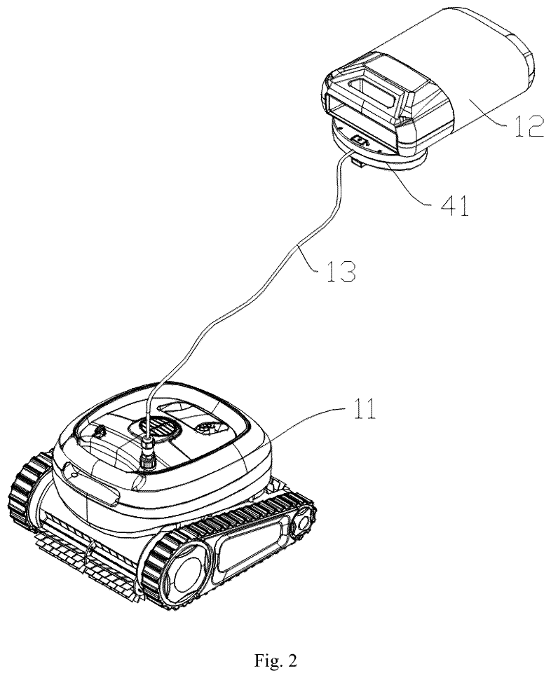

FIG. 3 shows a schematic partial view of a cleaning robot according to the present invention.

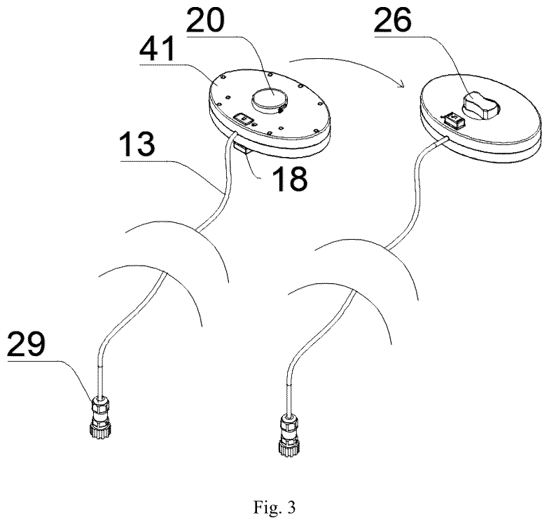

FIG. 4 schematically illustrates the internal structure of an antenna enclosure according to the present invention.

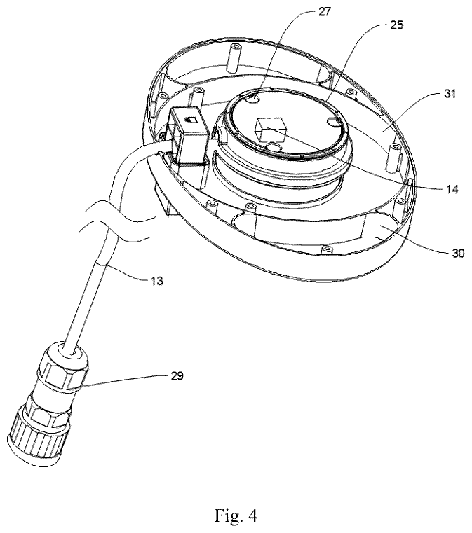

FIG. 5 is a schematic structural overview of an unlocking means according to the present invention.

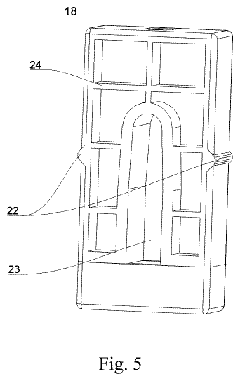

FIG. 6 is a schematic structural view of a male engagement member according to the present invention.

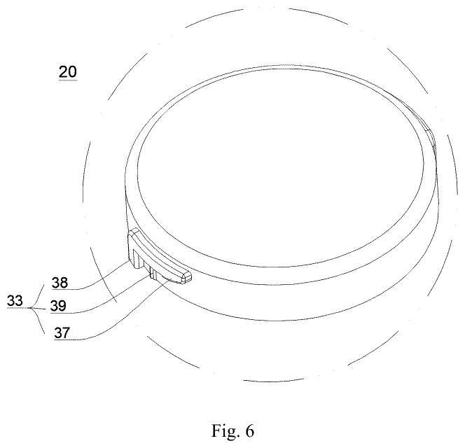

FIG. 7 shows an assembly of a reel and a grip according to the present invention.

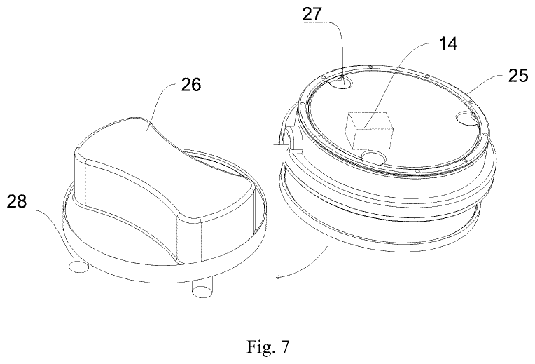

FIG. 8 is a schematic structural view of a female engagement member according to the present invention.

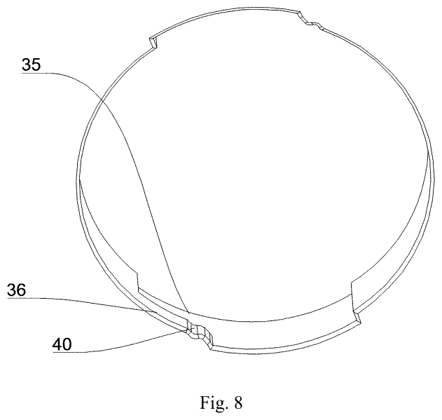

FIG. 9 shows steps in an assembly process according to the present invention.

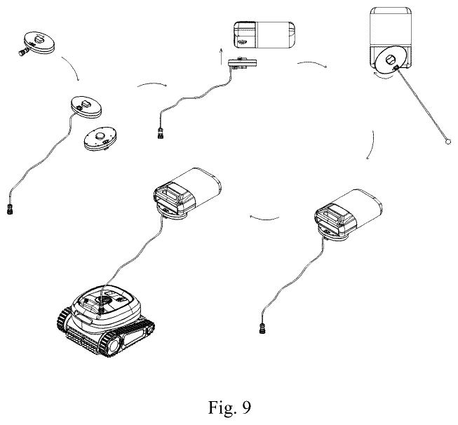

FIG. 10 shows steps in a disassembly process according to the present invention.

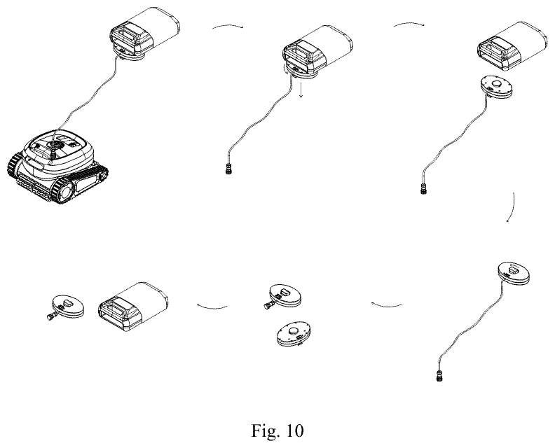

### DETAILED DESCRIPTION OF THE PREFERRED EMBODIMENTS

Aspects, objects, and advantages of the present invention will be described in greater detail below with reference to the accompanying drawings, which illustrate embodiments thereof.

It is to be noted that, as used herein, the terms “center”, “up”, “down”, “left”, “right”, “vertical”, “horizontal”, “inside”, “outside” and so on may be used herein to describe orientations or positional relationships as viewed in the annexed figures. They are for convenience and ease of description of the present invention only and do not indicate or imply that the described apparatus or element must assume, or be constructed or operated in, a particular orientation. Therefore, they are not to be construed as limiting the present invention. In addition, as used herein, the terms “first”, “second” and “third” are intended only for illustration and are not to be construed as indicating or implying relative importance.

As shown in the figures, embodiments of the present invention provide an antenna enclosure for floating on a swimming pool. The antenna enclosure can float on the surface of water. A reel which can be rotated with a rotator is provided in the antenna enclosure, and a signal box is in turn provided in the reel. The antenna enclosure 41 is often connected to a swimming pool cleaning robot by a signal line. According to one embodiment, during use, the swimming pool cleaning robot sinks at the bottom of a swimming pool, while the antenna enclosure 41 floats on the surface of water. In order to move the robot, a signal is sent to the antenna enclosure 41, which then relays it to the swimming pool cleaning robot deployed at the bottom of the pool through the signal line. In this way, transmission of the signal will not be blocked by water.

Embodiments of the present invention also provide a swimming pool cleaning robot employing the above antenna enclosure 14 for floating on a swimming pool. It includes a first cleaning device 11 and a second cleaning device 12. In one embodiment, the first cleaning device 11 sinks at the bottom of water in a swimming pool to clean the bottom of the swimming pool, while the second cleaning device 12 floats on the surface of water to clean the surface. The first cleaning device 11 typically includes a roller brush for removing algae from the bottom of a swimming pool. It also includes a strainer and can suck dirty water through the strainer in the form of water flow, thereby achieving cleaning of the water. The second cleaning device 12 typically includes a strainer for skimming the surface of water to collect leaves and other waste.

In one embodiment, the signal box 14 is provided in the second cleaning device 12 and with a first signal cable 13. A first end of the first signal cable 13 is connected to the signal box 14, and a second end of the first signal cable 13 is connected to the first cleaning device 11. As water would typically significantly interfere with signal transmission, the signal box 14 is provided in the second cleaning device 12 that is deployed at the surface of water, and signals for controlling the first cleaning device 11 can be transmitted to the first cleaning device 11 through the first signal cable 13.

In one embodiment, the antenna enclosure 41 is detachably attached to the second cleaning device 12, and the first signal cable 13 is connected to the antenna enclosure 41. Detachably attaching the antenna enclosure 41 to the second cleaning device 12 facilitates access to the first signal cable 13 for use and allows replacement with another antenna enclosure 41 optionally with another first signal cable 13 having a different length, as required by a particular application or swimming pool condition, thereby resulting in improved applicability.

In particular, in one embodiment, the antenna enclosure 41 is provided at the bottom of the second cleaning device 12. As the second cleaning device 12 floats on the surface of water during use, providing the antenna enclosure 41 at the bottom of the second cleaning device 12 will not affect cleaning efficiency of the second cleaning device 12.

In one embodiment, the antenna enclosure 41 includes a first reel cover 15 and a second reel cover 16. The first reel cover 15 and the second reel cover 16 are threadedly coupled to each other.

The signal box 14 is disposed in the antenna enclosure 41, and the first reel cover 15 and the second reel cover 16 together define a cable aperture 19 in the vicinity of a lock slot 17. The first signal cable 13 is passed through the cable aperture 19 and connected to the signal box 14 in the antenna enclosure 41. The signal box 14 houses therein a signal antenna and a PCB board. Examples of a suitable technique that can be used for signal transmission may include, but are not limited to, WiFi, zigbee, Bluetooth and even infrared (IR). In case of IR transmission, the antenna enclosure 41 and the signal box 14 may be provided with transparent light guides, and the first signal cable may be implemented as a light-guiding glass optic capable of signal transmission. In preferred embodiments, WiFi is used for signal transmission.

In another embodiment, the first reel cover 15 and the second reel cover 16 are integrally formed, or separately fabricated and then coupled together by ultrasonic welding. In this way, better waterproofness can be obtained.

In one embodiment, the first reel cover 15 and the second reel cover 16 together define the lock slot 17 in the form of a through slot. An unlocking means 18 complementary in shape to the lock slot 17 is disposed in the lock slot 17. The unlocking means 18 defines stop ribs 22 at its opposite sides and a central cable recess 23 matching the cable aperture 19 in width. The unlocking means 18 can be used to lock or unlock the first signal cable 13 to disallow or allow it to be unwound out and wound in. This can avoid an unpredictable length of the first signal cable 13 being unwound out, which may impair cleaning efficiency, or even get tangled and stuck on the device.

In another embodiment, the unlocking means 18 is made of plastic and includes reinforcing ribs 24. Typically, it is not made of wood, metal or ceramic. Alternatively, the unlocking means 18 may be provided in the form of a rope.

In one embodiment, the first reel cover 15 of the antenna enclosure 41 has a male engagement member 20, and the second cleaning device 12 has a female engagement member 21 complementary in shape to the male engagement member 20.

A rotatable reel 25 is provided within the antenna enclosure 41. A grip 26 is on the side of the antenna enclosure 41 away from the second cleaning device 12. The reel 25 defines rotating slots 27, and the grip 26 defines rotating teeth 28, which can be inserted into, and act in cooperation with, the respective rotating slots 27.

In one embodiment, the first signal cable 13 is provided at its second end with an aviation connector 29, through which it is connected to the first cleaning device 11. The aviation connector 29 is used because the first cleaning device 11 sinks at the bottom of water and therefore requires higher water tightness.

In one embodiment, the antenna enclosure 41 is elliptical, and ends of the elliptical antenna enclosure 41, which oppose each other along a long axis thereof, define grip locations 30. The antenna enclosure 41 defines a circular, central cable storage cavity 31. The elliptical antenna enclosure 41 provides a longer arm of force and associated points of application, which allow for easier removal or tightening.

In one embodiment, the male engagement member 20 includes a male plug 32 fixed on the side of the first reel cover 15 proximal to the second cleaning device 12. The male plug 32 defines symmetrical male protrusions 33. The female engagement member 21 includes a female socket 34 defining female recesses 35 and female protrusions 36 for mating with the male protrusions 33. The male protrusions 33 are generally F-shaped and each include a leading insertion portion 37, a trailing securing portion 38 joined to one end of the leading insertion portion 37 and a stop ridge 39 joined to one side of the leading insertion portion 37. The stop ridges 39 can engage in mating stop grooves 40 in the female protrusions 36.

During assembly, the male plug 32 of the male engagement member 20 is aligned with the female socket 34 of the female engagement member 21. In particular, the male protrusions 33 are aligned with the female recesses 35. The antenna enclosure 41 is then rotated to insert the leading insertion portions 37 of the male protrusions 33 into the female recesses 35 until the stop ridges 39 engage into the stop grooves 40 in the female protrusions 36. Thus, the antenna enclosure 41 is attached to the second cleaning device 12. In order to detach them, a small force can be exerted to disengage the stop ridges 39 from the stop grooves 40, and the male engagement member 20 can be then loosened from the female engagement member 21. Thus, the antenna enclosure 41 can be detached from the second cleaning device 12.

In one embodiment, use of the system includes the steps as follows:
S1: In response to a need for use, take the antenna enclosure 41 out and unwind a length of the first signal cable 13 out of the antenna enclosure 41, which is 1-1.2 times, preferably 1.1 times a depth of water in a swimming pool to be cleaned.
S2: In case of the antenna enclosure 41 being provided with the unlocking means 18, press the unlocking means 18 to unlock the first signal cable 13, and after an appropriate length of the first signal cable 13 has been unwound out, press the unlocking means in the opposite direction to again lock the first signal cable 13.
S3: In case of the antenna enclosure 41 being provided with the grip 26, rotate the grip 26 in a first direction to unwind the first signal cable 13.
S4: Connect the first signal cable 13 to the first cleaning device 11. In case of the first signal cable 13 being provided with the aviation connector 29, this is tightened into a corresponding feature of the first cleaning device 11.
S5: Attach the antenna enclosure 41 to the second cleaning device 12. In case of the antenna enclosure 41 defining the male engagement member 20 and of the second cleaning device 12 defining the female engagement member 21, the attachment is accomplished by tightening the male engagement member 20 into the female engagement member 21 in the first direction.
S6: After use, separate the first signal cable 13 from the first cleaning device 11. In case of the aviation connector 29 being provided, the separation is accomplished by loosening the aviation connector 29.
S7: Detach the antenna enclosure 41 from the second cleaning device 12. In case of the antenna enclosure 41 defining the male engagement member 20 and of the second cleaning device 12 defining the female engagement member 21, the detachment is accomplished by loosening the male engagement member 20 from the female engagement member 21 in a second direction.
S8: Wind the first signal cable 13 back into the antenna enclosure 41. In case of the antenna enclosure 41 being provided with the unlocking means 18, the unlocking means 18 is pressed to unlock the first signal cable 13, and after the first signal cable 13 has been recovered, is pressed in the opposite direction to again lock the first signal cable 13.
S9: In case of the antenna enclosure 41 being provided with the grip 26, rotate the grip 26 in the second direction to wind the first signal cable 13.

The description presented above is merely that of preferred embodiments of the present invention and is not intended to limit the scope thereof in any sense. Any and all changes, equivalent alternatives and modifications made according to the principles of the invention are intended to fall within the scope thereof.

What is claimed is:

1. A swimming pool cleaning robot comprising a first cleaning device and a second cleaning device,
wherein the second cleaning device has an antenna enclosure, and the first cleaning device sinks at the bottom of water to clean the bottom of a swimming pool, while the second cleaning device floats on a surface of the swimming pool to clean the surface thereof; and the second cleaning device has a first signal cable;
the first signal cable is connected to the antenna enclosure with a first end, and a second end of the first signal cable is connected to the first cleaning device; and
the antenna enclosure is located at the bottom of the second cleaning device, having a reel in a signal box and rotatable with a rotator.

2. The swimming pool cleaning robot of claim 1, wherein the antenna enclosure comprises a first reel cover and a second reel cover, which are fixedly coupled to each other and together define a lock slot extending therethrough and provided therein with an unlocking means, wherein:
the first reel cover and the second reel cover also together define a cable aperture in the vicinity of the lock slot; the first signal cable is passed through the cable aperture of the antenna enclosure and connected to the signal box in the antenna enclosure; and the signal box is provided therein with a signal antenna and a PCB board.

3. The swimming pool cleaning robot of claim 2, wherein the first reel cover of the antenna enclosure defines a male engagement member and in that the second cleaning device defines a female engagement member complementary to the male engagement member in shape.

4. The swimming pool cleaning robot of claim 3, wherein the unlocking means is complementary in shape to the lock slot and defines stop ribs on its opposite sides and a central cable recess matching the cable aperture in width.

5. The swimming pool cleaning robot of claim 3, wherein the unlocking means is made of plastic and defines reinforcing ribs.

6. The swimming pool cleaning robot of claim 3, wherein the antenna enclosure is provided with a grip on the side away from the second cleaning device, wherein the reel in the antenna enclosure defines rotating slots, and the grip defines mating rotating teeth capable of insertion into the rotating slots.

7. The swimming pool cleaning robot of claim 2, wherein the first signal cable is provided with an aviation connector at the second end and connected to the first cleaning device via the aviation connector, wherein the antenna enclosure is elliptical and defines grip locations at ends of its long axis and a circular, central cable storage cavity.

8. The swimming pool cleaning robot of claim 4, wherein the male engagement member comprises a male plug fixed on the side of the first reel cover proximal to the second cleaning device, the male plug defining symmetrical male protrusions, wherein:
the female engagement member comprises a female socket defining female recesses and female protrusions for mating with the male protrusions;
the male protrusions are generally F-shaped and each comprise a leading insertion portion, a trailing securing portion joined to one end of the leading insertion portion and a stop ridge joined to one side of the leading insertion portion; and
the female protrusions define stop grooves for mating with the stop ridges.

9. A method of using the swimming pool cleaning robot comprising:
an assembly process comprising the steps of:
S1: in response to a need for use, taking the antenna enclosure out and unwinding a length of the first signal cable out of the antenna enclosure, which is 1-1.2 times a depth of water in a swimming pool to be cleaned;
S2: in case of the antenna enclosure being provided with the unlocking means, pressing the unlocking means to unlock the first signal cable, and after an appropriate length of the first signal cable has been unwound out, pressing the unlocking means in the opposite direction to again lock the first signal cable;
S3: in case of the antenna enclosure being provided with the grip, rotating the grip in a first direction to unwind the first signal cable;
S4: connecting the first signal cable to the first cleaning device, wherein in case of the first signal cable being provided with the aviation connector, the aviation connector is tightened into a corresponding feature of the first cleaning device; and
S5: attaching the antenna enclosure to the second cleaning device, wherein in case of the antenna enclosure defining the male engagement member and of the second cleaning device defining the female engagement member, the attachment is accomplished by tightening the male engagement member into the female engagement member in the first direction; and
a disassembly process comprising the steps of:
S6: after use, separating the first signal cable from the first cleaning device, wherein in case of the aviation connector being provided, the separation is accomplished by loosening the aviation connector;
S7: detaching the antenna enclosure from the second cleaning device, wherein in case of the antenna enclosure defining the male engagement member and of the second cleaning device defining the female engagement member, the detachment is accomplished by loosening the male engagement member from the female engagement member in a second direction;
S8: winding the first signal cable back into the antenna enclosure, wherein in case of the antenna enclosure being provided with the unlocking means, the unlocking means is pressed to unlock the first signal cable, and after the first signal cable has been recovered, is pressed in the opposite direction to again lock the first signal cable; and
S9: in case of the antenna enclosure being provided with the grip, rotating the grip in the second direction to wind the first signal cable.
